(19) United States
(12) Patent Application Publication
(10) Pub. No.: US 2009/0164572 A1
(43) Pub. Date: Jun. 25, 2009

(54) APPARATUS AND METHOD FOR CONTENT ITEM ANNOTATION

(75) Inventors: Patricia M. Charlton, Bayswater (GB); Jonathan S. Teh, Basingstoke (GB)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/960,898

(22) Filed: Dec. 20, 2007

(51) Int. Cl. G06F 15/16

(52) U.S. Cl. 709/204

(57) ABSTRACT

An apparatus for content item annotation comprises a user group processor (105) for determining a group of communication identities associated with a group of users associated with a user of the apparatus. A user group communication processor (109) monitors user group communications within the group of users and generates first characterising data for these where the first characterising data comprises at least one of context and content data for the user group communications. A communication processor (103) receives a content item in a first communication from a communication identity of the group of communication identities and a data processor (111) generates second characterising data for the first communication. An annotation processor (113) then generates annotation data for the content item in response to the first characterising data and the second characterising data. Specifically, suggested annotation data may be generated on the basis of characteristics of previous communications within a user group linked to the current communication.

### FIELD OF THE INVENTION

The invention relates to an apparatus and a method for content item annotation and in particular, but not exclusively to automatic annotation of visual content items such as digital images or video sequences.

### BACKGROUND OF THE INVENTION

In recent years, the availability and provision of multimedia and entertainment content has increased substantially. For example, the number of available television and radio channels has grown considerably and the popularity of the Internet has provided new content distribution means. In addition, the increased digitalisation and ways of encoding content has led to an increased distribution of many different types of content items including digital pictures, music, audio clips, video clips etc.

Consequently, users are increasingly provided with a plethora of different types of content from different sources. In order to identify and select the desired content, the user must typically process large amounts of information which can be very cumbersome and impractical.

Accordingly, significant resources have been invested in research into techniques and algorithms that may provide an improved user experience and assist a user in identifying and selecting content. In order to facilitate content item management, searching and processing, it is common practice to annotate content items by creating data indicative of the content and associating it with the content.

The success of searching often depends on the availability of suitable data describing the content. However, a problem faced by many content owners is that they have large archives of content which has never been annotated, or have only been provided with insufficient annotation. Also, the amount of privately generated content items has increased substantially with e.g. photos and video clips often being generated by individual consumers. Such content items typically require individual annotation.

Annotation of content items is often performed manually where a person reviews the content items and selects or generates suitable data. However, this approach is very cumbersome, time consuming and resource intensive and is typically not practical for privately generated content items.

In order to address this, methods for automatic or semi-automatic annotation of content items have been proposed.

Specifically, automatic content analysis may be performed which identifies specific objects or characteristics of content items and generates data for the content to reflect the identified characteristics. An example of such automatic annotation systems can be found in for example United States Patent Applications US 2005/0114325 which describes generation of data from an automated analysis of images or US 2005/00071865 which describes a system wherein data for digital content can be automatically generated and then modified by a user.

However, a problem with current approaches is that they tend to generate suboptimal annotations and/or to be time consuming and/or resource demanding. Accordingly, these approaches tend to be suboptimal in many scenarios, such as for personally and non-commercially generated content items.

Hence, an improved system of annotation of content items would be advantageous and in particular a system allowing facilitated automated or semi-automated annotation generation, reduced complexity, improved annotations, reduced resource demands, reduced processing times and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a method of content item annotation, the method comprising: determining a group of communication identities associated with a group of users associated with a first user; generating first characterising data for user group communications within the group of users, the first characterising data comprising at least one of context data and content data for the user group communications; receiving a content item in a first communication from a communication identity of the group of communication identities; generating second characterising data comprising at least one of context data and content data for at least one of the content item and the first communication; and generating annotation data for the content item in response to the first characterising data and the second characterising data.

The invention may allow improved and/or facilitated content item annotation. The invention may in particular allow an automated or semi-automated generation of annotation data for content items.

The Inventors have realised that user communications within a given user group, such as a social network, may provide particularly suitable information about the content or characteristics of content item communicated within such a user group. The Inventors have furthermore realised that such information can effectively be extracted and used to provide or assist in generation of annotation data. For example, by restricting the communications to group user communications, the probability that communications may relate to topics or content relevant for the content item may be increased.

For example, the generated annotation data may be based on a consideration of the context of the content item where the context is determined based on communications within a specific user group such as a social community or social network. The particular content and context of the exchanges between the users of such groups can be used to derive possible annotation data for a given content item.

For example, the context of a user group set up by a user to correspond to a community or social network can be used to deduce annotation data. E.g. the characteristics of the communications within this group can be used to learn about how the content collections are used and shared (between groups or individuals). The user group may specifically be a personal group set up by the first user to contain members that are explicitly known by one another and for whom the user has some explicit knowledge.

The user group communications may comprise any communication involving a user (not being the first user) of the group of users as either a source or a destination of the communication.

The annotation data may be any kind of data providing some form of description of a characteristic of the content or context of the content item. For example, the annotation data can be metadata (data about data) and/or can e.g. include text terms and numerical data.

According to another aspect of the invention there is provided an apparatus for content item annotation, the apparatus comprising: a unit for determining a group of communication identities associated with a group of users associated with a user of the apparatus; a unit for generating first characterising data for user group communications within the group of users, the first characterising data comprising at least one of context data and content data for the user group communications; a unit for receiving a content item in a first communication from a communication identity of the group of communication identities; a unit for generating second characterising data comprising at least one of context data and content data for at least one of the content item and the first communication; and a unit for generating annotation data for the content item in response to the first characterising data and the second characterising data.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of a content item annotation apparatus in accordance with some embodiments of the invention; and

FIG. 2 is an illustration of an example of a method of content item annotation in accordance with some embodiments of the invention.

### DETAILED DESCRIPTION OF SOME EMBODIMENTS OF THE INVENTION

The following description focuses on embodiments of the invention applicable to semantic annotation of content items such as pictures or video clips. In particular, the annotation may be of content items generated by individual consumers and users and transmitted to other users or consumers. However, it will be appreciated that the invention is not limited to this application.

The content item annotation of the described embodiments is based on evaluation of previous communications within a user group. The communications may specifically be message communications, such as emails, Short Message Service (SMS) messages etc. The communications may be supported by any suitable communication system including for example a cellular communication system and/or an Internet based communication system.

The user group can be specified by the individual user and will typically correspond to a set of contacts for the user, such as users of communities or social networks to which the user belongs. The communications of the communication system which are taking place between users of the user group are monitored and content and context data characterising the communications are generated and stored. When a user receives a new content item, the stored information is then used to generate a prediction of the annotation(s) that is(are) likely to be relevant to the content.

Specifically, the data for the user group communications can be stored in a knowledgebase and clustered with relevant annotation(s). When a new content item is encountered, the most likely annotations can be determined from the information of the knowledgebase and presented to the user. The user can then select from the proposed annotations (e.g. in a similar way to predictive text) or can manually modify the proposed annotations. Any manual inputs can then be fed back to the knowledgebase to improve the prediction.

The approach may provide improved automated or semi-automated annotation. In particular, the information and constraints imposed by the community or social network to which the user belongs can be used to generate annotations that are more likely to meet the user's preferences and requirements. For example, user groups are often defined between like minded people sharing interests. Thus, previous information exchange and/or content item annotations within that user group are likely to be relevant for a content item communicated within the user group and are likely to reflect preferences of the user for annotation data.

The approach may be particularly attractive for mobile applications as it may for example facilitate the generation of annotation suggestions based on suitable communications and information associated therewith. This information may typically be readily available in a mobile device such as a mobile phone or a cellular communication system user equipment.

A contextual conversation analysis of the previous communications within a user group can specifically be used to infer annotation data for a content item communicated within the user group and, thus, is likely to have a high content correlation with other communications and/or content items of the user group.

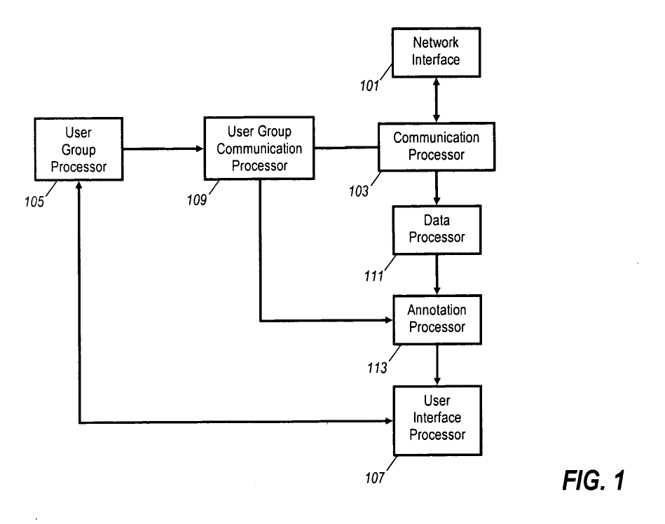

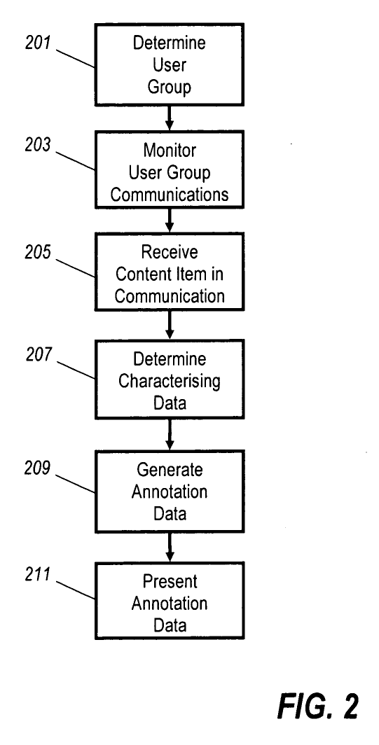

FIG. 1 illustrates an example of a content item annotation apparatus in accordance with some embodiments of the invention. The operation of the content item annotation apparatus will be described with reference to the method of content annotation illustrated in FIG. 2.

The content item annotation apparatus comprises a network interface 101 which is operable to interface the content item annotation apparatus to a communication network. In the example, the content item annotation apparatus is a user equipment of a cellular communication system, such as a Global System for Mobile communication (GSM) or a Universal Mobile Telecommunication System (UMTS), and accordingly the network interface 101 comprises the required or desired functionality for communicating over the air interface of the cellular communication system. Furthermore, the cellular communication system provides Internet access to the user equipment through a suitable interworking function.

The user equipment which comprises the content item annotation apparatus is operable to communicate with other communication units. For example the user equipment may communicate with other user equipments of the cellular communication system and/or may communicate with communication units coupled to the Internet. Specifically, the user equipment can exchange messages, such as email or text (SMS) messages, with other communication units. Accordingly, the user equipment/content item annotation apparatus includes a communication processor 103 comprising all the required or desired functionality for enabling such communications.

The content item annotation apparatus furthermore comprises a user group processor 105 which is operable to execute step 201 of the method of FIG. 2 wherein a user group is determined.

In the example, the user group is generated from a user input and the user group processor 105 is coupled to a user interface processor 107 which provides functionality for interfacing with the user of the apparatus. For example, the user interface processor 107 can comprise a display and keyboard as well as functionality for providing user inputs to or receive user output from the remaining elements of the content item annotation apparatus.

In the system, a manual user input is provided to the user group processor 105 via the user interface processor 107. The user input provides a selection of one or more users for the user group. Each of the users is represented by a communication identity that allows the content item annotation apparatus to identify communications from and to the individual user. For example, each user may be specified by an email address, a phone number or an Internet Protocol (IP) address (or e.g. a name linked to the email address, phone number or IP address).

It will be appreciated that in some embodiments the user may generate the user group by selecting specific users/communication identities from an available set of users/communication identities. For example, based on an address book or contact list of the user equipment, the user may select the contacts to be included in the specific user group. Alternatively or additionally, the user may directly specify a communication identity for a user to be included in the user group, such as for example by specifically entering an email address of the user to be included in the user group.

It will be appreciated that in some embodiments the user group generation may alternatively or additionally be automatically or semi-automatically generated e.g. in response to communication characteristics associated with the communications performed by the user equipment.

In the example, the user manually generates a personal user group comprising other users represented by their communication identities. The user group is set up to comprise members that are explicitly known by one another and for who the user typically has some explicit knowledge. For example, a user group may be defined by the user to comprise a number of members that all share the same interest. For example, a football interested user group may be defined.

The content item annotation apparatus furthermore comprises a user group communication processor 109 which is coupled to the communication processor 103 and the user group processor 105. The user group communication processor 109 executes step 203 wherein the communications within the user group are monitored. Specifically, the user group communication processor 109 may be fed a copy of all messages received or transmitted by the communication processor 103. It may then compare the communication identities of the source or destination of the messages to the defined user group. All messages which contain a communication identity belonging to the user group (either as a recipient or an originator) are further processed whereas all other messages are ignored by the user group communication processor 109.

The user group communication processor 109 can then proceed to determine first characterising data for the communications (which specifically can be messages) that have been found to involve a communication identity of the user group (e.g. messages which are either transmitted to a communication identity of the user group or are received from a communication identity of the user group).

The characterising data may be context data or content data for and is in the specific embodiments both context data and content data.

Context data may include various characteristics and parameters relating to a context of the communication, such as for example a time of the communication, and originator of the communication, a destination for the communication, a type of communication etc.

In the specific example, the user group communication processor 109 generates context data for each user group communication where the context data specifically comprises the communication identities of all users involved in the user group communication (i.e. either as originator or as destination), a time of the communication and whether any content items are included in the communication (e.g. as an attachment to an email).

The content data may be any characteristic or parameter which reflects or is derived from the content of a communication. Specifically for each communication, a suitable content analysis may be applied to derive content data that reflects the content of the communication.

For example, a text analysis can be applied to text elements of received communications. Such a text analysis may for example extract a number of terms that may be suitable for characterising the content.

In the example, the communications are text based messages, such as emails or SMS messages, and a text analysis is performed on each message to extract a set of key terms where each term can represent a single key word or a key concept.

The text analysis may for example use Natural Language Processing (NLP) algorithms to generate the keywords. Thus, NLP algorithms may be applied to extract key terms of the consumed text document such as e.g. nouns and Named Entities (known predetermined names of specific entities) etc. The key concepts can be extracted using classic common word filtering and using rules and a priori knowledge such as e.g. that any non-common word either before or after the word ‘photo’ is likely to be a description of a photo attached to the email.

It will be appreciated that different approaches for analyzing the whole or part of the consumed text document and for automatically extracting key terms and concepts will be known to the person skilled in the art.

Thus for each received message, the user group communication processor 109 generates characterising data comprising both context and content data.

In some embodiments, the user group communication processor 109 may simply store the individual data for each communication. However, in other embodiments the generated data may be further processed and specifically the communications may be clustered together based on a similarity criterion. Thus, based on such an approach the user group communication processor 109 may generate clusters of communications that are relatively similar (e.g. tending to involve the same people and/or be related to the same content etc). Furthermore, this clustering approach may also generate characterising data that provides a suitable characterisation of the entire cluster rather than of the individual messages. For example, a text vector may be generated for each cluster indicating the most common keywords or key concepts within the cluster.

Furthermore, based on the cluster characterising data, a topic classification process may be used to determine one or more topics that can be associated with the communications of the individual cluster.

As will be appreciated by the skilled person, a suitable topic classification algorithm can be based on calculation of the distance between a search result term vector and a set of prototype topic vectors (created a priori). The distance metric used for this purpose can e.g. be either Euclidean (by use of term frequency) or Jaccard distance.

The clustering of the communications may for example use a clustering algorithm such as a k-means or isodata clustering algorithm.

A k-means clustering algorithm initially defines k clusters with given initial parameters (e.g. term vectors). The term vectors for the search results are then matched to the (term vectors of the) k clusters. The parameters for each cluster are then recalculated based on the search results that have been assigned to each cluster. The algorithm then proceeds to reallocate the search results to the k clusters in response to the updated parameters for the clusters. If these operations are iterated a sufficient number of times, the clustering converges resulting in k groups of search results having similar properties.

The first characterising data generated by the user group communication processor 109 may be used to generate annotation data for a content item received in a current communication within the user group. Thus, the communication processor 103 may in step 205 receive a current communication, such as an email message, from a communication identity of the user group with the communication comprising a content item such as a digital photo and/or a video clip. The content item may specifically be a content item generated by the originating user.

The communication processor 103 can in response to the detection of the content item in a communication from a user of the user group forward this communication to a data processor 111 coupled to the communication processor 103.

The data processor 111 may in step 207 proceed to generate second characterising data for the communication.

The generated characterising data may be either context data or content data for the communication and/or the content item but in the specific embodiments the second characterising data comprises both context data and contents eight.

Context data may include various characteristics and parameters relating to a context of the communication such as for example a time for the communication, an originator of the communication, a destination for the communication, a type of communication etc. Alternatively or additionally, the context data may include various characteristics and parameters relating to a context of the content item such as a time of generation, a location where content item was generated etc.

The content data may be any characteristic or parameter which reflects or is derived from the content of the current communication or the content item. Specifically for each communication, a suitable content analysis may be applied to derive content data that reflects the content of the communication.

The data processor 111 may specifically apply the same algorithm for extracting content and context data as that applied by the user group communication processor 109.

For example, when the user receives a communication (e.g. an email message with a photo and an associated text, a header etc.), the data processor 111 can extract concepts from the communication (e.g. as keywords or (using a metadata structure) as a taxonomy or ontology). Typically, a content item is received with some form of accompanying text such as a header, title, the sender's name etc and simple extraction of relevant information can be based on text analysis (For example, using filtering and matching techniques, such as common phrases used when sending photos etc.)

Furthermore, in some embodiments the content data may alternatively or additionally be derived from the content item itself. For example, the content item may include annotation data describing the content. In the specific embodiments, such data is extracted and included in the second characterising data.

The generated second characterising data is fed from the data processor 111 to an annotation processor 113 which is furthermore coupled to the user group communication processor 109 from which it receives the first characterising data.

The annotation processor 113 executes step 209 wherein annotation data is generated for the content item in response to the first characterising data and the second characterising data.

The annotation processor 113 may initially determine a subset of the first characterising data for which a match criterion to the second characterising data is met.

The match criterion may for example include a requirement that the derived content data is sufficiently similar to each other. For example, the derived text vector of keywords and key concepts for the current communication may be compared to derived text vectors of the first characterising data. If a distance measure between the text vectors is less than a predetermined threshold, the associated previous communication(s) will be included in the subset and otherwise they will be ignored.

Alternatively or additionally, the match criterion can comprise a requirement that context data of the subset of first characterising data matches context data of the second characterising data. For example, it may be required that the communications originated with the same communication identity of the user group and/or that the communication is received within a given time interval.

The annotation processor 113 may then proceed to generate the annotation data by generating such annotation data in response to the first characterising data comprised in the extracted subset. Thus, the annotation processor 113 may evaluate previous communications to find communications that are likely to relate to very similar subject matter. The annotation data can then be generated based on e.g. content data of the correlated previous communications.

As a simple example, the annotation processor 113 may search through the first characterising data generated for previous communications and select one or more communications for which the first characterising data meets the second characterising data generated for the current communication. The annotation processor 113 may then proceed to extract data from the first characterising data and include this in the annotation data. For example, one or more keywords or key concepts from the selected previous communications can be added to the annotation data for the current content item.

As a more complex example, the annotation processor 113 may proceed to match the generated second characterising data to the different clusters generated by the previously described clustering process. The closest cluster may be selected and the annotation data may be generated in response to characterising data for this cluster. For example, terms of the cluster text vector may be included in the annotation data. As another example, if the cluster is associated with a specific topic (or content topic category), a number of terms may be predefined for this topic and the annotation processor 113 may add such terms to the annotation data. As a specific example, if a cluster of communications has been found to be associated with the topic of top league football matches, the terms “top league” and “football” may be added to the annotation data.

The annotation processor 113 is coupled to the user interface processor 107 which is arranged to execute step 211 wherein the annotation data is presented to the user.

For example, when the user selects to view the received message and associated content item, a display of the user equipment may also present the generated annotation data. Thus, the suggested automatically generated annotation data can be presented to the user the first time he opens the attachment to the email.

The user may furthermore be presented with a number of options allowing him to select how this automatically generated annotation data will be used. For example, the user may be presented with the option of accepting the suggested annotation data, rejecting the suggested annotation data or modifying the suggested annotation data. In the latter case, the user may manually modify, delete or add terms to the annotation data.

It will be appreciated, that in other embodiments other means of presenting be suggested annotation data to the user may be applied. For example, the user may be asked to manually enter suitable annotation terms and if the beginning of a term is found to match a term of the automatically generated annotation data, the user input may automatically be completed by introducing this term. Thus, the automatically generated annotation data may be used to provide a predictive text function for annotating content items.

It will be appreciated that the described system may provide suitable annotation data in many embodiments. The annotation data may be automatically generated and submitted to the user for verification, acceptance or rejection. The system furthermore explicitly exploits characteristics and constraints associated with user groups, such as social networks or communities. Specifically, by isolating communications within a user group, a much closer correlation and correspondence between a current communication and the characteristics of previous communications can be achieved thereby providing improved annotation accuracy based on previous communications and interactions within the user group.

In some embodiments, the content item annotation apparatus can link the current communication comprising the content item to be annotated to a set of user group communications. The annotation data is then generated in response to the first characterising data for this set of user group communications.

For example, as previously described, the incoming communication may be linked to a cluster of previous communications and the annotation data may be generated on the basis thereof.

Thus, the user group communication processor 109 can select an individual set of associated communications in response to the communications meeting a suitable match criterion. Furthermore, for the incoming communication, a suitable set of previous communications may be selected if the first characterising data for this set meets a match criterion with respect to the characterising data generated by the data processor 111 for the current communication.

It will be appreciated, that any suitable match criteria may be used for dividing the previous communications into the sets or for matching the current communication to the one (or more) of the sets. For example, one or more of the following parameters may be considered in one or both of the match criteria:
A communication identity of a user involved in the user group communications. For example, one or both of the match criteria may require that all communications within the same set either originate or are addressed to a specific communication identity or group of communication identities. For example, email messages may only be included in the same set if they are from or to the same email address (or set of email addresses).
A header of the user group communications. Headers may also be used as a particularly strong indication of the content, topic or purpose of the communication. For example, email headers often contain a short description of the content of the email. As an example, one or both of the match criteria may require that the header data is identical (or e.g. contains at least one identical term) for the considered communications to meet the criteria.
A text content of the user group communications. For example, text analysis may be applied to extract keywords and one or both of the criteria may require that text vectors of extracted keywords have a distance measure below a given threshold. For example, it may be required that in order for two communications to meet a match criteria they must both include more than a given number of identical or synonymous keywords.
A content item characteristic for a content item included in the user group communications. The content item characteristic may for example be an indication of whether a content item is included in the communication, a type of content item, a time of creation of the content item etc. For example, one or both match criteria may only be met by communications comprising a digital photo taken within a given time interval.
A time characteristic for the user group communications. For example, a transmitted or received time of the communications may be used to evaluate one or both criteria. For example, two communications may only be considered to meet the match criteria if the time difference between them is less than a given threshold.

Thus, the content item annotation apparatus may specifically find communications that can be closely linked to the current communication and which therefore are likely to relate to the same issue as the current communication.

Accordingly, the annotation processor 113 will generate the annotation data by prioritising first characterising data for the linked set higher than first characterising data for previous communications that are not in the linked set. Indeed, in many embodiments only the characterising data for the linked set will be considered and all communications not included in the linked set will be ignored.

In some embodiments, the linking may seek to associate the current communication with previous communications being part of a communication exchange or chain of which the current communication is also part.

For example, an email communication exchange often arises by the involved parties replying to received emails. For example, the user of the content item annotation apparatus may transmit an email to two other users of the user group. One of these users may reply to the email and the user of the content item annotation apparatus may again respond to this reply message. The other user may then reply to the second message and this reply may for example comprise a digital photo taken by the second user. When this email is received by the content item annotation apparatus, this may proceed to automatically generate annotation data which can be presented to the user when he views the digital photo (or for example when he saves the photo). In accordance with the previously described approach, the generated annotation data is thus not just based on the last email message from the second user but may be derived from all emails of the communication exchange.

The previously described parameters may provide an efficient way of linking a current communication to previous communications of such a communication exchange. For example, the two match criteria may require that the considered communications all involve the three users of the user group (and only these three users), have the same header and are communicated within the last, say, five days.

In some embodiments, the generation of either the first and/or second characterising data may include comparing a user identity associated with a communication to user identities of a stored contact list. For example, the user equipment may contain a list of contacts for the user, and some or all of the contacts may potentially comprise additional data associated with the user. Such data may for example be automatically generated data, such as a communication frequency, frequent keywords extracted from communications with this user etc. Alternatively or additionally, the data may be manually entered by the user of the user equipment and may for example describe information which is known to the user about the contact. Such data may for example include names of the contact's children, topics known to be of interest to the user etc.

Thus, when characterising data is generated for a specific communication, the content item annotation apparatus may for example detect that the communication is received from a specific communication identity which is included in the contact list. It may then proceed to retrieve the data of the contact list and may for example directly include some of this in the generated characterising data, such as e.g. a typical topic for the user. Alternatively or additionally, the contact data may be used as part of the generation of the characterising data. For example, if the message comprises a name found to correspond to the name of one of the contact's children, the keyword “children” may be included in the keywords.

In some embodiments, the user interface processor 107 may not only present the generated annotation data but may also present links to the previous communications included in the matching set of communications. Hence, the user may easily access the previous communications that are estimated to be closely related to the current communication. This may for example facilitate a user's manual modification of the generated annotation data. In some embodiments, these links may alternatively or additionally be included in the annotation data for the content item. Thus, the annotation mechanism may create soft links to the related messages (and may also allow the user to browse these links and e.g. delete any unwanted links).

In some embodiments, the first characterising data generated by the user group communication processor 109 may in itself comprise annotation data. For example, a previous communication may include a content item which may have been annotated by the source of the communication. For example, a digital photo may have been annotated by another user and sent to the user of the content item annotation apparatus. In such a case, the user group communication processor 109 may extract the annotation data and store this as part of the first characterising data for this communication. This data may then be used to annotate content items of subsequent messages, for example received from the same user.

In the following, a specific example of the high level operation of the content item annotation apparatus for a specific message exchange is given.

In the example, Julie first sends Peter a text: “Enjoyed the party. Rex seemed to be enjoying himself. Did you get any good photos?”

The content item annotation apparatus operation proceeds to match the word Rex with a contact list to generate contextual cues from this list.

Peter then sends a text to Julie with an attached photo: “Cool time was had by all. Here's a fun photo of Rex and you painting the town red”.

The content item annotation apparatus proceeds to link the messages based on time span and related concepts such as Party, Photo, Rex.

The content item annotation apparatus proceeds to match e.g. the term Rex with the previous message.

Metadata concepts are then created for the photo:

### 1. Rex

### 2. Party

3. time/date

Metadata is then created for the message exchange:

### 1. Peter

### 2. Party

### 3. Photo

4. links

The generated metadata is presented to the user who selects suitable metadata as the annotation data. E.g. the user open or stores the photo and the system offers the automated metadata annotations. The user then selects or edits these and the result is stored with the photo.

The resulting metadata may for example be suitable for searching through stored content items. E.g. if Julie would like to search for photos of a party then the words party and photo would return a filtered set of results. Other contextual cue attributes such as Peter and Rex would return a shorter list. This enhances and creates new methods for generating annotations and helping users manage their messages and content.

In the following a specific detail example of the operation of the content item annotation apparatus will be provided.

In the example, Oscar sends Julie a text with header a picture for you . . . “Thanks for coming to the zoo Jane's birthday a week ago. I'm just back and going through the photos, so I thought I'd send you some of mine featuring Christian. More photos coming under separate cover”

The content item annotation apparatus operation proceeds to extract key names e.g. Jane, Photo, Christian, birthday to generate contextual cues from this list.

Oscar sends Julie a photo with header “a picture for you”. The content item annotation apparatus then uses the previous message sent by Oscar, this is due to the fact that the time the message is sent is within in a normal communication range, which means that there is a high likelihood (probability) that the messages are related. However the second message contains very little text for analysis (just a picture for you). The content item annotation apparatus makes a link between the first and second message sent by Oscar and thus can suggest previous and highly likely annotations for the picture.

The conversation analysis means in this example that text and contact information are linked (E.g. sent and received text and contact info of sender, key metadata properties for all photos Jane, Christian, Oscar, Zoo, Birthday, photo).

Metadata concepts are then created for the photo:

### 1. Jane,

### 2. Christian,

### 3. Birthday

### 4. Zoo

Metadata is then created for the message exchange:

### 1. Julie

### 2. Oscar

3. Photos linked as cluster (for searching)
4. links conversation (for searching)

### 5. Jane,

### 6. Christian,

### 7. Birthday,

### 8. Zoo

The items Jane, Christian, Oscar, Birthday and zoo for the second and subsequent photos that only contain the header item “photo for you” get their annotations from the conversation/communication exchange inherited/derived from the first message.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of content item annotation, the method comprising:
determining a group of communication identities associated with a group of users associated with a first user;
generating first characterising data for user group communications within the group of users, the first characterising data comprising at least one of context data and content data for the user group communications;
receiving a content item in a first communication from a communication identity of the group of communication identities;
generating second characterising data comprising at least one of context data and content data for at least one of the content item and the first communication; and
generating annotation data for the content item in response to the first characterising data and the second characterising data.

2. The method of claim 1 wherein the generation of annotation data comprises determining a subset of the first characterising data in response to the second characterising data in accordance with a match criterion; and generating the annotation data comprises generating the annotation data by including data from the first subset of characterising data in the annotation data.

3. The method of claim 2 wherein the match criterion comprises a requirement for a match of context data of the subset of first characterising data and context data of the second characterising data; and wherein generating the annotation data comprises generating the annotation data by including content data from the first subset of characterising data in the annotation data.

4. The method of claim 1 wherein the generating of the first characterising data comprises determining at least some of the first characterising data by text analysis of text content of at least one of the user group communications.

5. The method of claim 4 wherein the at least some of the first characterising data comprises a set of extracted terms from the at least one of the user group communications.

6. The method of claim 5 wherein generating annotation data comprises including at least one term of the set of extracted terms in the annotation data.

7. The method of claim 1 wherein the first characterising data for a user group communication comprises a communication identity of a user involved in the user group communication.

8. The method of claim 1 wherein the second characterising data for the first communication comprises a communication identity of a user involved in the first communication.

9. The method of claim 1 further comprising linking the first communication to a set of user group communications; and wherein generating the annotation data comprises generating the annotation data in response to first characterising data for the set of user group communications.

10. The method of claim 9 further comprising generating the set of user group communications as a plurality of user group communications having associated first characterising data meeting a first criterion.

11. The method of claim 10 wherein the first criterion comprises a consideration of at least one parameter selected from the group consisting of:
a communication identity of a user involved in the user group communications;
a header of the user group communications;
a text content of the user group communications;
a content item characteristic for a content item included in the user group communications; and
a time characteristic for the user group communications.

12. The method of claim 9 wherein the linking is in response to the second characterising data and the first characterising data of the first set meeting a match criterion.

13. The method of claim 12 wherein the match criterion comprises a consideration of at least one parameter selected from the group consisting of:
a communication identity of a user involved in the user group communications;
a header of the user group communications;
a text content of the user group communications;
a content item characteristic for a content item included in the user group communications; and
a time characteristic for the user group communications.

14. The method of claim 9 wherein generating the annotation data comprises prioritising first characterising data associated with the set of user group communications higher than first characterising data not associated with the set of user group communications.

15. The method of claim 9 further comprising generating links to the user group communications of the set of user group communications and presenting the links to a user.

16. The method of claim 9 wherein generating annotation data comprises determining a content topic category for the set of user group communications in response to the first characterising data for the set of user group communications and including predetermined annotation data associated with the content topic category in the annotation data.

17. The method of claim 1 wherein the first characterising data comprises annotation data for a content item in a user group communication of the user group communications.

18. The method of claim 1 wherein determining of the group of communication identities comprises determining the group of communication identities in response to a user selection of the group of users.

19. The method of claim 1 wherein generating at least one of the first characterising data and the second characterising data comprises comparing a user identity associated with at least one of the user group communications and the first communication to user identities of a stored contact list.

20. An apparatus for content item annotation, the apparatus comprising:
a unit for determining a group of communication identities associated with a group of users associated with a user of the apparatus;
a unit for generating first characterising data for user group communications within the group of users, the first characterising data comprising at least one of context data and content data for the user group communications;
a unit for receiving a content item in a first communication from a communication identity of the group of communication identities;
a unit for generating second characterising data comprising at least one of context data and content data for at least one of the content item and the first communication; and
a unit for generating annotation data for the content item in response to the first characterising data and the second characterising data.
